(19) United States
(12) Patent Application Publication
(10) Pub. No.: US 2005/0276437 A1
(43) Pub. Date: Dec. 15, 2005

(54) Speaker device and method of fabricating the same

(76) Inventor: Teruaki Kaiya, Yamagata-ken (JP)

Correspondence Address: ARENT FOX PLLC, 1050 CONNECTICUT AVENUE, N.W., SUITE 400, WASHINGTON, DC, 20036, US

(21) Appl. No.: 11/149,449

(22) Filed: Jun. 10, 2005

(30) Foreign Application Priority Data
Jun. 11, 2004 (JP) JP 2004-173608

(51) Int. Cl. H01R 4/50

(52) U.S. Cl. 381/409; 381/410

(57) ABSTRACT

A speaker device is provided, in which a tinsel wire is prevented from falling, while the efficiency of an operation of soldering the tinsel wire is improved. A speaker device includes a tinsel wire having one end being connected to a voice coil within a frame and the other end being connected to an external input terminal section provided outside of the frame. The external input terminal section is provided with a cylindrical part having a through hole and a terminal strip having a through hole in communication with that of the cylindrical part. The tinsel wire is inserted through the through holes so that an end of the tinsel wire led from the through holes is connected to the external input terminal section.

### BACKGROUND OF THE INVENTION

The present invention relates to a speaker device and a method of fabricating the same.

The present application claims priority from Japanese Application No. 2004-173608, the disclosure of which is incorporated herein by reference.

FIG. 1 is a view for illustrating a conventional speaker device 1 (described in Japanese Unexamined Patent Application Publication No. 6-14383). The speaker device 1 includes a center pole 2 made of a magnetic material provided in the center. A cross section of a yoke 3 including the center pole 2 forms a reverse T-shape having a step. A ring-shaped magnet 4 having a given thickness is provided on a circumferential end of the yoke 3 so as to keep a given distance with the center pole 2 provided in the center. A ring-shaped plate 5 is provided on an upper surface of the magnet 4. The yoke 3, the magnet 4 and the plate 5 form a magnetic circuit.

A frame 6 made of a metal, which is formed on the plate 5, has a funnel shape including a flat part 6A. One end of a damper 7 is bonded to the flat part 6A through an adhesive. A gap 8 is provided between the center pole 2 and an inner circumference of the plate 5. In the gap 8, a cylindrical voice coil bobbin 9 surrounding the center pole 2 and a voice coil 10 wound around the voice coil bobbin 9 are provided. A part of the side face of the voice coil bobbin 9, which is situated above the voice coil 10, is fixed to the other end of the damper 7. A further upper part is fixed to a diaphragm 11. The other end of the diaphragm 11 is connected to an edge of the frame 6.

A terminal section T is an external input terminal provided on an extended part 6B formed by externally extending the frame 6 beyond the flat part 6A. One end of a tinsel wire K is connected to the voice coil 10 whereas the other end is connected to the terminal section T. In this manner, a voice signal received by the terminal section T is supplied through the tinsel wire K to the voice coil 10. A dust cap 13 is provided on an upper face of the voice coil bobbin 9.

The conventional speaker device 1 shown in FIG. 1 has the following problems described with reference to FIGS. 2(a) and (b) FIG. 2(a) is a perspective view of the conventional speaker device 1 illustrated in FIG. 1, and FIG. 2(b) is an enlarged view of the terminal section T shown in FIG. 2(a).

According to the conventional example, the terminal section T is formed by fixing the tinsel wire K and the extended part 6B of the frame 6 to each other by a solder hd through an eyelet 14 on the extended part 6B. In this case, one end of the tinsel wire K is connected to the voice coil 10 through the diaphragm 11, whereas the other end passes through the extended part 6B as shown in FIG. 2(b). Normally, in such a case, the tinsel wire K is often soldered after keeping a largely bent shape. Therefore, the tinsel wire K sometimes falls at its foot (a circled part in FIG. 2(b)) to be broken. In order to prevent the tinsel wire K from falling, the conventional techniques cope with this problem by applying silicon or the like onto this part (the foot) so as to reinforce the tinsel wire K. Specifically, the process according to the conventional techniques requires a step of applying silicon or the like for reinforcement described above after a soldering step, thereby complicating the fabrication process.

The frame 6 of the speaker device 1 as described above includes: frame leg parts 6a for supporting the diaphragm 11 and the like; and frame opening (or frame window) parts 6b that are open for a connecting operation of the tinsel wire K and the like. One end of the tinsel wire K is connected to the diaphragm 11, whereas the other end passes through the frame opening part 6b so as to be connected to the terminal section T provided on the flat extended part 6B outside of the frame 6, the extended part 6B being formed by using an outer frame of the frame opening part 6b. The terminal section T provided at the other end of the tinsel wire K is provided on the extended part 6B outside of the frame 6 as described above mainly for smoothening the soldering operation of the terminal section T; if the terminal section T externally protrudes, the soldering operation is facilitated. Specifically, for such a reason of the operation, the tinsel wire K was generally soldered on the extended part 6B outside of the frame 6 in the conventional techniques.

A method giving priority to design freedom is also conceivable. According to this method, the terminal section T is formed on the flat part 6A inside of the frame 6 so as to be freely provided. In such a case, it is certain that design freedom is increased. However, a fine operation requiring extremely high precision is needed; that is, a precise position of a hole preformed at a predetermined position of the frame, through which the tinsel wire is to be passed, is required to be known so as to pass the other end of the tinsel wire K through the hole while soldering the tinsel wire K within the frame 6. In such a situation, the frame leg part 6a impedes the soldering operation and the like to prevent a smooth operation of forming the terminal section T within the frame 6. Since the operation efficiency is lowered as described above, the above-mentioned method is not appropriate.

Therefore, the location, at which the terminal section T can be formed, is limited to be on the extended part 6B outside of the frame 6. Therefore, various restrictions are inevitably imposed at the step of designing the speaker device 1. Specifically, the position of the tinsel wire K is required to be always aligned with the position of the frame opening part 6b (the extended part 6B). As a result, the design freedom is reduced to have no small effect on the realization of design of various shapes, the attachment of the speaker device and the like.

### SUMMARY OF THE INVENTION

The present invention copes with the above-described problems as an example of the object. Specifically, the present invention has an object of providing a speaker device and a method of fabricating the same for: preventing a tinsel wire on a terminal section from falling to prevent the breaking of the tinsel wire so as to stabilize electrical conduction through the tinsel wire; allowing free arrangement of the terminal section, to which an end of the tinsel wire is connected, on a frame so as to easily perform a connecting operation through soldering or the like while providing high design freedom to allow various designs and a high degree of freedom at attachment.

In order to achieve the above-described object, the speaker device according to the present invention includes at least a structure according to each of the following aspects of the invention.

According to a first aspect of the invention, a speaker device comprises a tinsel wire having one end being connected to a voice coil within a frame and the other end being connected to an external input terminal section provided outside of the frame, wherein a cylindrical part having a through hole is provided for the external input terminal section, and the tensile wire is inserted through the through hole so as to be led therefrom to be connected to the external input terminal section.

According to a second aspect of the present invention, there is provided a method of fabricating a speaker device including a tinsel wire having one end being connected to a voice coil within a frame and the other end being connected to an external input terminal section provided outside of the frame. The method comprises the steps of: providing a cylindrical part having a through hole for the external input terminal section; inserting the tinsel wire through the through hole; and leading the tinsel wire from the through hole so as to connect the tinsel wire to the external input terminal section.

### BRIEF DESCRIPTION OF THE DRAWINGS

These and other objects and advantages of the present invention will become clear from the following description with reference to the accompanying drawings, wherein:

FIG. 1 is a sectional view showing a speaker device according to a conventional technique;

FIG. 2(a) is a perspective view showing the speaker device according to the conventional technique, and FIG. 2(b) is an enlarged view of a terminal section shown in FIG. 2(a);

FIG. 3 is a half-sectional view showing a speaker device according to an embodiment of the present invention;

FIG. 4 is a side view showing the speaker device shown in FIG. 3;

FIG. 5 is a plan view of the bottom side of the speaker device shown in FIG. 4;

FIGS. 6(a) and 6(b) are a side view and a plan view, each showing another external input terminal section of the speaker device according to the embodiment of the present invention; and

FIG. 7 is a functional view showing an operation of attaching a tinsel wire to the external input terminal section shown in FIG. 6.

### DETAILED DESCRIPTION OF THE PREFERRED EMBODIMENTS

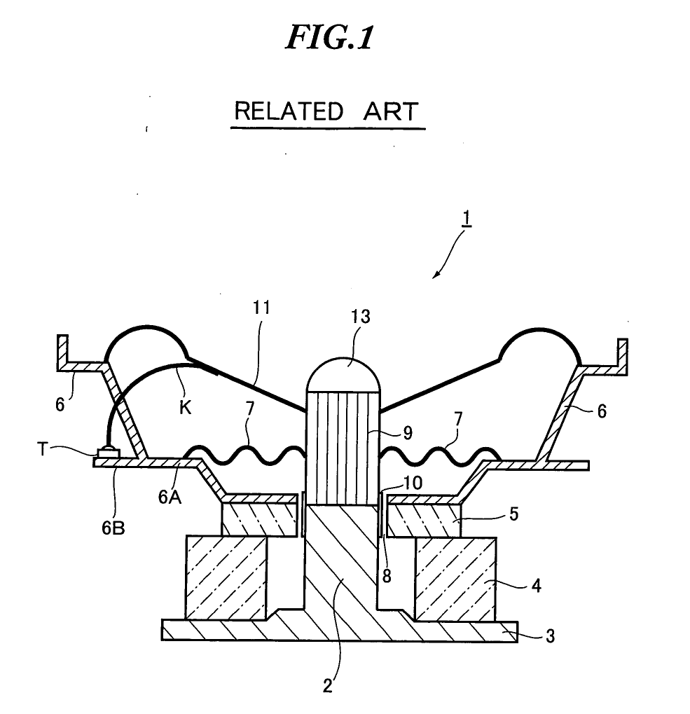

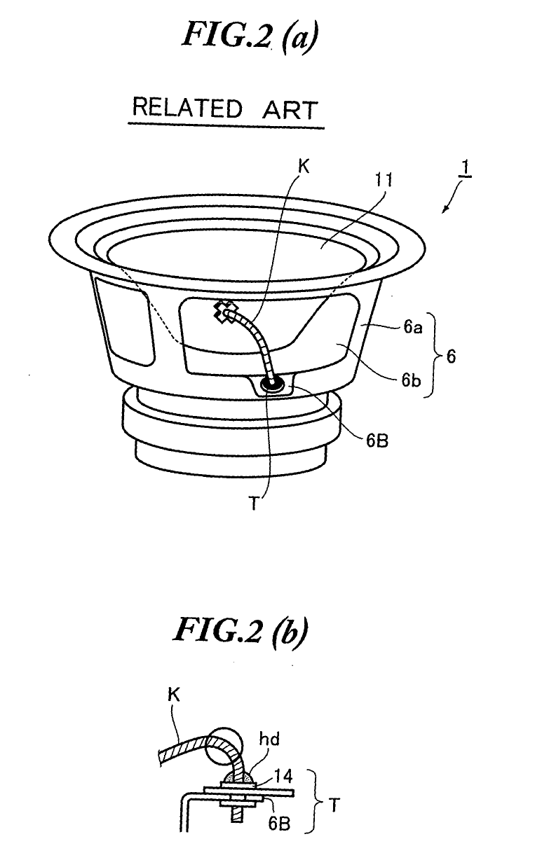

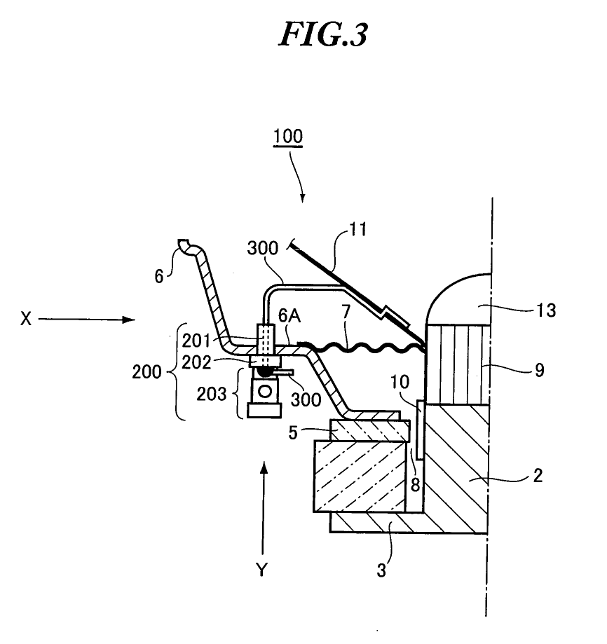

Hereinafter, embodiments of the present invention will be described with reference to the accompanying drawings. FIG. 3 is a half-sectional view showing a speaker device 100 according to an embodiment of the present invention. In FIG. 3, the same components as those of the conventional speaker device 1 shown in FIGS. 1 to 2(b) are denoted by the same reference numerals, and the description thereof is herein omitted.

The speaker device 100 according to the embodiment of the present invention includes a tinsel wire 300. One end of the tinsel wire 300 is connected to the voice coil 10 within the frame 6, whereas the other end is connected to an external input terminal section 200 provided for the frame 6. The external input terminal section 200 includes: a cylindrical part 201 having a through hole; a terminal strip 202 formed integrally with the cylindrical part 201; and a connector 203 connected to the terminal strip 202 so as to be electrically conductive. Each of the terminal strip 202 and the cylindrical part 201 has a through hole so that their through holes are in communication with each other.

The external input terminal section 200 is attached to the flat part 6A corresponding to a part of the frame 6. The cylindrical part 201 is attached through a hole not shown (hereinafter, referred to as a frame hole) preformed in the flat part 6A of the frame 6 so as to protrude inside the frame 6.

Moreover, the terminal strip 202 and the connector 203 are provided outside of the frame 6. An output terminal of external equipment (for example, an amplifier or the like) is connected to the connector 203. A signal received from the external equipment is transmitted to the voice coil 10 through the terminal strip 202 and the tinsel wire 300.

An end of the tinsel wire 300 is connected to the voice coil 10 inside the frame 6, whereas the other end is connected to the external input terminal section 200. More specifically, the other end of the tinsel wire 300 is inserted from an end of the cylindrical part 201 (hereinafter, referred to as an insertion end) to pass through the through holes in the cylindrical part 201 and the terminal strip 202 being in communication with each other. After the inserted end is led from the bottom face side of the terminal strip 202, it is fixed by a solder or the like so as to be connected to the external input terminal section 200.

Next, a method of attaching the external input terminal section 200 shown in FIG. 3 to the flat part 6A of the frame 6 will be described. First, a frame hole (not shown) is preformed at a desired position of the flat part 6A. Then, the insertion end of the cylindrical part 201 of the external input terminal section 200 is inserted into the frame hole from the bottom face side of the frame 6 to be attached to the flat plate 6A so that the cylindrical part 201 protrudes inside the frame 6. In this manner, the external input terminal section 200 according to this embodiment of the present invention is attached so that the cylindrical part 201 protrudes inside the frame 6 through the frame hole while the terminal strip 202 is situated outside the frame 6.

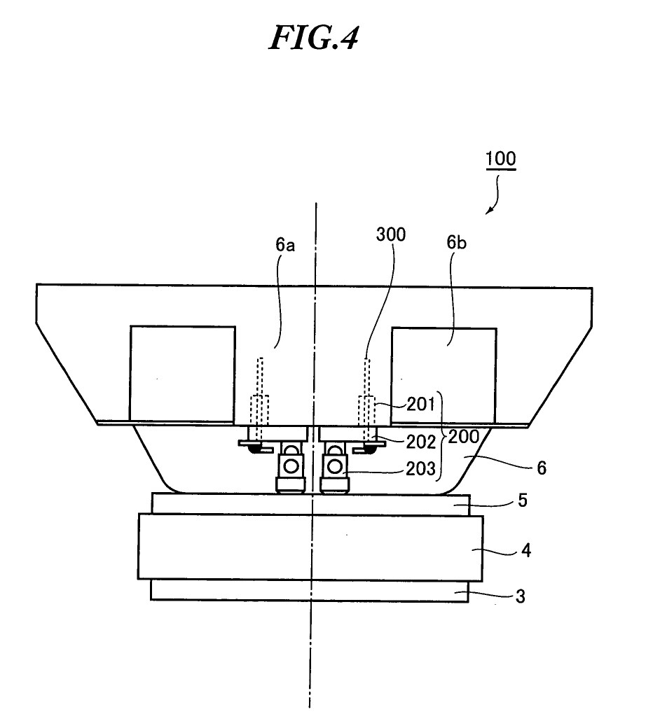

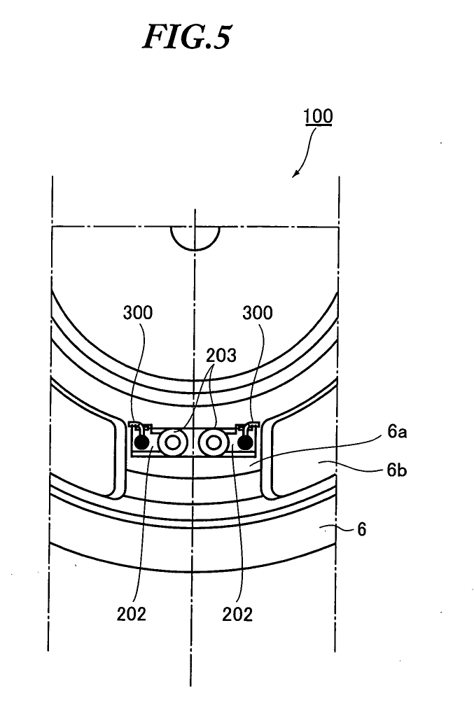

FIG. 4 is a side view of the speaker device 100 shown in FIG. 3 viewed from the side face side (an X-direction indicated with an arrow). FIG. 5 is a plan view of the speaker device 100 viewed from the bottom face side (a Y-direction indicated with an arrow) In the embodiment of the present invention, the external input terminal section 200 including the cylindrical part 201 having the through hole is attached onto the terminal strip 202 at a position corresponding to the frame leg part 6a as shown in FIGS. 4 and 5.

More specifically, the external input terminal section 200 is attached to the flat part 6A contiguous to the flame leg part 6a by providing the frame hole therein. Each of the connectors 203 is provided on the bottom face side of the terminal strip 202 so as to be offset from the position of the cylindrical part 201 formed on the surface side of the terminal strip 202.

In the embodiment of the present invention as described above, even if the external input terminal section 200 is attached at the position corresponding to the frame leg part 6a, the operation for connecting the tinsel wire 300 to the external input terminal section 200 is as simple as follows owing to the cylindrical part 201 of the external input terminal section 200. Specifically, hands are inserted from the frame opening parts 6b provided on the right and the left so as to insert the end of the tinsel wire 300 into the through hole of the insertion end of the cylindrical part 201. After the end of the tinsel wire 300 is passed so as to be led from the bottom face side of the external input terminal section 200, it is fixed on the bottom face by soldering or the like. More specifically, since a fine soldering operation inside the frame 6 is no more needed, an efficient connecting operation of the tinsel wire can be realized.

Although the external input terminal section 200 is attached at the position corresponding to the frame leg part 6a in this embodiment of the present invention, the position of attachment of the external input terminal section 200 is not limited thereto. The external input terminal section 200 may be attached so as to be partially or entirely located at the position corresponding to the frame opening part 6b (the flat part 6A contiguous to the frame opening parts 6b). Moreover, for the convenience of design or the like, the frame hole can be freely formed at any position of the flat part 6A of the frame 6 so as to attach the external input terminal section 200. Furthermore, the position of the frame hole is not limited to the flat part 6A; the frame hole may be formed at any position of the frame 6 so as to attach the external input terminal section 200. The position of the external input terminal section 200 may be freely arranged for the convenience of design. Moreover, since the external input terminal section 200 includes the cylindrical part 201 in the embodiment of the present invention, the operation of attaching the tinsel wire 300 can be easily implemented even if the external input terminal section 200 is situated at any position of the frame 6.

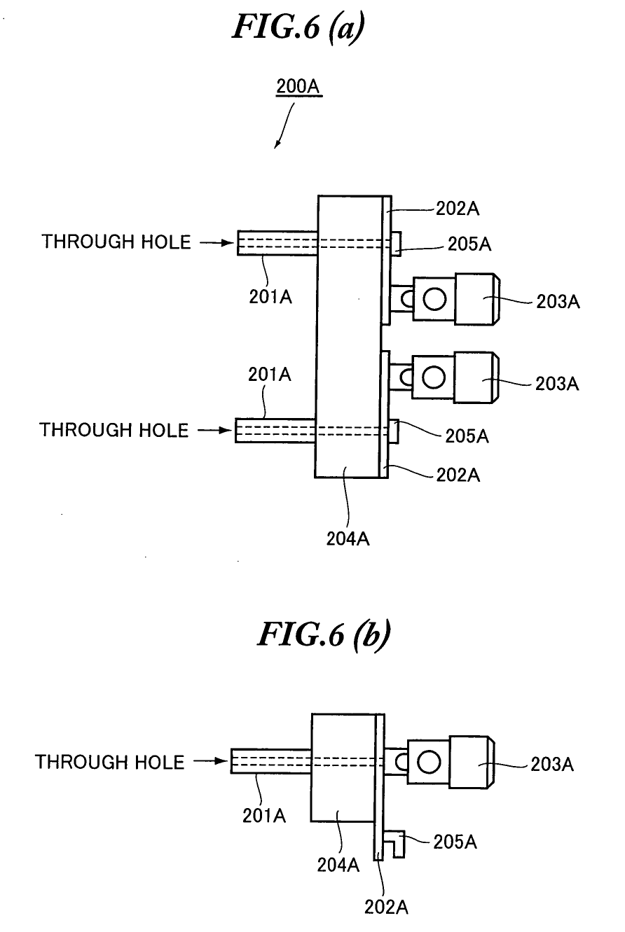

FIGS. 6(a) and 6(b) are a plan view (FIG. 6(a)) and a side view (FIG. 6(b)) showing another embodiment of the external input terminal section including the terminal strip 202 and the cylindrical part 201 shown in FIGS. 3 to 5.

As shown in FIGS. 6(a) and 6(b), an external input terminal section 200A in this embodiment includes a support body 204A between two cylindrical parts 201A and terminal strips 202A made of a metal. Herein, the cylindrical parts 201A and the support body 204A are integrally formed by the same member; particularly preferably, they can be formed by a flexible member (for example, an elastomer, a rubber or the like).

Moreover, each of the cylindrical part 201A, the support body 204A and the terminal strip 202A includes a through hole, which is in communication with each other. On the bottom face side of the terminal strip 202A, the connector 203A that is electrically conductive with the terminal strip 202A and a fixing part 205A for fixing the tinsel wire are formed.

Each of the terminal strips 202A serves to electrically connect the tinsel wire led from the bottom face side and the connector 203A with each other. In the case where two connectors 203A are formed as shown in FIG. 6(a), the connectors 203A are formed so that the terminal strips 202A connected to the respective connectors 203A are separated from each other. The fixing part 205A is required to be positioned merely in consideration of the position of the connector 203A provided on the terminal strip 202A. For example, as shown in FIG. 6(b), the terminal strip 202A may be formed so as to be extended beyond the support body 204A in a direction opposite to the connector 203A such that the fixing part 205A may be formed at the extended position. The shape of the fixing part 205A or the like is not particularly limited as long as it allows soldering without fail.

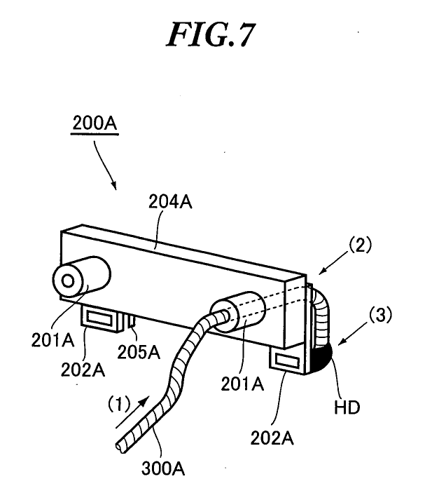

FIG. 7 is a functional view showing an operation of connecting the tinsel wire 300A to the external input terminal section 200A in FIG. 6. FIG. 7 shows a state where the cylindrical part 201A has already been inserted into the frame hole of the frame 6 described above.

First, the tinsel wire 300A is inserted through the through hole at the insertion end of the cylindrical part 201A ((1) in FIG. 7) so as to pass through the through holes in the cylindrical part 201A, the support body 204A and the terminal strip 202A, which are in communication with each other. Then, the tinsel wire 300A is led from the bottom face side of the terminal strip 202A ((2) in FIG. 7). Subsequently, the led end of the tinsel wire 300A is fixed to the fixing part 205A on the bottom face of the terminal strip 202A by using a solder HD ((3) in FIG. 7). By the above-described steps, the operation of connecting the external input terminal section 200A and the tinsel wire 300A to each other is completed.

According to the embodiment as described above, each of the cylindrical parts 201A formed on the terminal strip 202A is formed so as to surround the tinsel wire 300A. Therefore, even if the tinsel wire 300A oscillates violently with the oscillation of the diaphragm 11, the tinsel wire 300A can be prevented from falling. Moreover, in the case where the cylindrical part 201A is formed by a flexible member such as a rubber, the tinsel wire 300A can be prevented from being broken even if the tinsel wire 300A is subjected to violent oscillations to apply an external stress to the cylindrical part 201A. As a result, a stable electrically conductive state of the tinsel wire 300A can be maintained.

In the above-described two embodiments of the present invention, the examples where the cylindrical parts 201 and 201A protrude inside the frame 6 have been disclosed. In the embodiments of the present invention, however, the external input terminal section having the cylindrical part 201 or 201A may be provided on an outer frame of the frame opening part 6b as in the conventional technique. Since the external input terminal section still includes the cylindrical part 201 or 201A in such an example, the tinsel wire can be prevented from falling as described above, thereby maintaining a stable electrically conductive state.

Therefore, in the embodiments of the present invention, the cylindrical part 201 or 201A is provided without reinforcement with silicon or the like as in the conventional technique. As a result, the step of applying silicon or the like can be eliminated to avoid the complication of the fabrication process.

As described above, according to the speaker device in the embodiments of the present invention, the external input terminal section is provided with the cylindrical part so as to prevent the tinsel wire from falling. In addition, if the cylindrical part is formed by a flexible member, the tinsel wire can be prevented from being broken even if the tinsel wire is subjected to violent oscillations or a stress. Therefore, a stable electrically conductive state of the tinsel wire can be maintained.

Moreover, in addition to the above-described effects, owing to the cylindrical part of the external input terminal section, the operation of connecting the tinsel wire can be simplified in the following manner even if the external imputer terminal section is to be attached at the position corresponding to the frame leg part of the speaker device. Specifically, when the tinsel wire and the external input terminal section are to be connected to each other, the tinsel wire is inserted through the through hole of the cylindrical part so that the led tinsel wire is soldered onto the bottom face. Since the tinsel wire can be connected only by the simple operation as described above, operation efficiency can be improved.

Furthermore, the external input terminal section can be attached at any position of the frame without taking the positional relationship between the frame leg part and the frame opening parts into consideration. Therefore, the degree of freedom of attachment of the speaker is remarkably improved, resulting in realization of the design of a speaker device satisfying various requests.

While there has been described what are at present considered to be preferred embodiments of the present invention, it will be understood that various modifications may be made thereto, and it is intended that the appended claims cover all such modifications as fall within the true spirit and scope of the invention.

1. A speaker device comprising:
a tinsel wire having one end being connected to a voice coil within a frame and the other end being connected to an external input terminal section provided outside of the frame, wherein
a cylindrical part having a through hole is provided for the external input terminal section, and the tensile wire is inserted through the through hole so as to be led therefrom to be connected to the external input terminal section.

2. The speaker device according to claim 1, wherein
the cylindrical part is integrally formed with a terminal strip of the external input terminal section.

3. The speaker device according to claim 1, wherein
the cylindrical part is formed by a flexible member attached to the terminal strip of the external input terminal section.

4. The speaker device according to claim 1, wherein
the cylindrical part is provided so that its insertion end protrudes inside the frame.

5. The speaker device according to claim 1, wherein:
the frame includes a frame leg part and a frame opening part; and
the external input terminal section is provided at a position corresponding to the frame leg part.

6. A method of fabricating a speaker device including a tinsel wire having one end being connected to a voice coil within a frame and the other end being connected to an external input terminal section provided outside of the frame, the method comprising the steps of:
providing a cylindrical part having a through hole for the external input terminal section;
inserting the tinsel wire through the through hole; and
leading the tinsel wire from the through hole so as to connect the tinsel wire to the external input terminal section.

7. The method of fabricating a speaker device according to claim 6, further comprising the steps of:
providing an insertion end of the cylindrical part so that the insertion end protrudes inside the frame; and
leading the tinsel wire through the cylindrical part outside of the frame.

8. The speaker device according to claim 2, wherein
the cylindrical part is provided so that its insertion end protrudes inside the frame.

9. The speaker device according to claim 3, wherein
the cylindrical part is provided so that its insertion end protrudes inside the frame.

10. The speaker device according to claim 2, wherein:
the frame includes a frame leg part and a frame opening part; and
the external input terminal section is provided at a position corresponding to the frame leg part.

11. The speaker device according to claim 3, wherein:
the frame includes a frame leg part and a frame opening part; and
the external input terminal section is provided at a position corresponding to the frame leg part.

12. The speaker device according to claim 4, wherein:
the frame includes a frame leg part and a frame opening part; and
the external input terminal section is provided at a position corresponding to the frame leg part.

13. The speaker device according to claim 8, wherein:
the frame includes a frame leg part and a frame opening part; and
the external input terminal section is provided at a position corresponding to the frame leg part.

14. The speaker device according to claim 9, wherein:
the frame includes a frame leg part and a frame opening part; and
the external input terminal section is provided at a position corresponding to the frame leg part.
